(19) United States
(12) Patent Application Publication
(10) Pub. No.: US 2010/0216904 A1
(43) Pub. Date: Aug. 26, 2010

(54) FOAM-FORMING COMPOSITIONS CONTAINING MIXTURES OF 2-CHLORO-3,3,3-TRIFLUOROPROPENE AND AT LEAST ONE HYDROFLUOROOLEFIN AND THEIR USES IN THE PREPARATION OF POLYISOCYANATE-BASED FOAMS

(75) Inventors: GARY LOH, Newark, DE (US); Joseph Anthony Creazzo, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/685,040

(22) Filed: Jan. 11, 2010

Related U.S. Application Data
(60) Provisional application No. 61/154,869, filed on Feb. 24, 2009.

(51) Int. Cl. C08G 18/28; C09K 3/00

(52) U.S. Cl. 521/131; 252/182.15

(57) ABSTRACT

Foam-forming compositions are disclosed which contain a mixture of 2-chloro-3,3,3-trifluoropropene and at least one hydrofluoroolefin. Also disclosed is a closed-cell polyurethane or polyisocyanurate polymer foam prepared from reaction of an effective amount of the foam-forming composition with a suitable polyisocyanate. Also disclosed is a process for producing a closed-cell polyurethane or polyisocyanurate polymer foam by reacting an effective amount of the foam-forming composition with a suitable polyisocyanate.

### BACKGROUND

1. Field of the Disclosure

The disclosure herein relates to foam-forming compositions comprising a mixture of 2-chloro-3,3,3-trifluoropropene and at least one hydrofluoroolefin and an active hydrogen-containing compounds, and using such compositions for producing polyurethane and polyisocyanurate foams.

2. Description of Related Art

Closed-cell polyisocyanate-based foams are widely used for insulation purposes, for example, in building construction and in the manufacture of energy efficient electrical appliances. In the construction industry, polyurethane/polyisocyanurate board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc.

All of these various types of polyurethane/polyisocyanurate foams require blowing agents (also known as foam expansion agents or foam expansion compositions) for their manufacture. Insulating foams depend on the use of halocarbon blowing agents, not only to foam the polymer, but primarily for their low vapor thermal conductivity, a very important characteristic for insulation value. Historically, polyurethane foams used CFCs (chlorofluorocarbons, for example CFC-11, trichlorofluoromethane) and HCFCs (hydrochlorofluorocarbons, for example HCFC-141b, 1,1-dichloro-1-fluoroethane) as the primary blowing agent. However, due to the implication of chlorine-containing molecules such as the CFCs and HCFCs in the destruction of stratospheric ozone, the production and use of CFCs and HCFCs has been restricted by the Montreal Protocol. More recently, hydrofluorocarbons (HFCs), which do not contribute to the destruction of stratospheric ozone, have been employed as blowing agents for polyurethane foams. An example of an HFC employed in this application is HFC-245fa (1,1,1,3,3-pentafluoropropane). The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future.

Japanese Patent No. 05179043 discloses and attempts to use cis-1,1,1,4,4,4-hexafluoro-2-butene as the blowing agent for polyurethane foams.

### BRIEF SUMMARY OF THE DISCLOSURE

This disclosure provides a foam-forming composition comprising: (a) a mixture of 2-chloro-3,3,3-trifluoropropene (HCFC-1233xf) and at least one hydrofluoroolefin; and (b) an active hydrogen-containing compound having two or more active hydrogens; wherein said at least one hydrofluoroolefin is selected from the group consisting of:
(i) hydrofluoroolefins of the formula E- or Z—R¹CH═CHR², wherein R¹ and R² are, independently, C₁ to C₆ perfluoroalkyl groups;
(ii) cyclic hydrofluoroolefins of the formula cyclo-[CX═CY(CZW)ₙ-], wherein X, Y, Z, and W, independently, are H or F, and n is an integer from 2 to 5, provided that not all X, Y, Z, and W are F; and
(iii) hydrofluoroolefins selected from the group consisting of: CHF₂CF═CH₂, CH₃CF═CF₂, CH₂FCF═CF₂, CH₂FCH═CF₂, CHF₂CH═CHF, CF₃CF═CHCF₃, CHF═CFCF₂CF₃, CHF₂CF═CFCF₃, (CF₃)₂C═CHF, CF₂═CHCF₂CF₃, CF₂═CFCHFCF₃, CF₂═CFCF₂CHF₂, CF₃CF₂CF═CH₂, CHF═CHCF₂CF₃, CHF═CFCHFCF₃, CHF═CFCF₂CHF₂, CHF₂CF═CFCHF₂, CH₂FCF═CFCF₃, CHF₂CH═CFCF₃, CF₃CH═CFCHF₂, CF₂═CFCF₂CH₂F, CF₂═CFCHFCHF₂, CH₂═C(CF₃)₂, CH₂FCH═CFCF₃, CF₃CH═CFCH₂F, CF₃CF₂CH═CH₂, CHF₂CH═CHCF₃, CH₃CF═CFCF₃, CH₂═CFCF₂CHF₂, CHF₂CF═CHCHF₂, CH₃CF₂CF═CF₂, CH₂FCF═CFCHF₂, CF₂═C(CF₃)(CH₃), CH₂═C(CHF₂)(CF₃), CH₂═CFCHFCF₃, CHF═CFCH₂CF₃, CHF═CHCHFCF₃, CHF═CHCF₂CHF₂, CHF═CFCHFCHF₂, CH₂═CHCF₂CHF₂, CF₂═C(CHF₂)(CH₃), CHF═C(CF₃)(CH₃), CH₂═C(CHF₂)₂, CF₃CF═CHCH₃, CH₃CF═CHCF₃, (CF₃)₂C═CHCF₃, CF₃CF═CHCF₂CF₃, CF₃CH═CFCF₂CF₃, CHF═CFCF₂CF₂CF₃, CF₂═CHCF₂CF₂CF₃, CF₂═CFCF₂CF₂CHF₂, CHF₂CF═CFCF₂CF₃, CF₃CF═CFCF₂CHF₂, CF₃CF═CFCHFCF₃, CHF═CFCF(CF₃)₂, CF₂═CFCH(CF₃)₂, CF₃CH═C(CF₃)₂, CF₂═CHCF(CF₃)₂, CH₂═CFCF₂CF₂CF₃, CHF═CFCF₂CF₂CHF₂, CH₂═C(CF₃)CF₂CF₃, CF₂═CHCH(CF₃)₂, CHF═CHCF(CF₃)₂, CF₂═C(CF₃)CH₂CF₃, (CF₃)₂CFCH═CH₂, CF₃CF₂CF₂CH═CH₂, CH₂═CFCF₂CF₂CHF₂, CF₂═CHCF₂CH₂CF₃, CF₃CF═C(CF₃)(CH₃), CH₂═CFCH(CF₃)₂, CHF═CHCH(CF₃)₂, CH₂FCH═C(CF₃)₂, CH₃CF═C(CF₃)₂, (CF₃)₂C═CHCH₃, CF₃CF₂CF═CHCH₃, CF₃C(CH₃)═CHCF₃, CH₂═CHCF₂CHFCF₃, CH₂═C(CF₃)CH₂CF₃, (CF₃)₂C═CHC₂F₅, (CF₃)₂CFCF═CHCF₃, CF₃CF₂CF₂CF₂CH═CH₂, CH₂═CHC(CF₃)₃, (CF₃)₂C═C(CH₃)(CF₃), CH₂═CFCF₂CH(CF₃)₂, CF₃CF═C(CH₃)CF₂CF₃, CF₃CH═CHCH(CF₃)₂, CF₃CF₂CF₂CF═CHCH₃, CH₂═CHCF₂CF₂CF₂CHF₂, (CF₃)₂C═CHCF₂CH₃, CH₂═C(CF₃)CH₂C₂F₅, CF₃CF₂CF₂C(CH₃)═CH₂, CF₃CF₂CF₂CH═CHCH₃, CH₂═CHCH₂CF₂C₂F₅, CF₃CF₂CF═CFC₂H₅, CH₂═CHCH₂CF(CF₃)₂, CF₃CF═CHCH(CF₃)(CH₃), (CF₃)₂C═CFC₂H₅, CF₃CH═CFCF₂CF₂C₂F₅, CF₃CF═CHCF₂CF₂C₂F₅, CF₃CF₂CH═CFCF₂C₂F₅, CF₃CF₂CF═CHCF₂C₂F₅.

This disclosure also provides a closed-cell polyurethane or polyisocyanurate polymer foam prepared from the reaction of an effective amount of the foam-forming composition and a suitable polyisocyanate.

This disclosure also provides a method for producing a closed-cell polyurethane or polyisocyanurate polymer foam. The method comprises reacting an effective amount of the foam-forming composition and a suitable polyisocyanate.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

The composition of this disclosure is a foam-forming composition comprising: (a) a mixture of HCFC-1233xf and at least one hydrofluoroolefin; and (b) an active hydrogen-containing compound having two or more active hydrogens; wherein said at least one hydrofluoroolefin is selected from the group consisting of:
(i) hydrofluoroolefins of the formula E- or Z—R¹CH═CHR², wherein R¹ and R² are, independently, C₁ to C₆ perfluoroalkyl groups;
(ii) cyclic hydrofluoroolefins of the formula cyclo-[CX═CY(CZW)ₙ—], wherein X, Y, Z, and W, independently, are H or F, and n is an integer from 2 to 5, provided that not all X, Y, Z, and W are F; and
(iii) hydrofluoroolefins selected from the group consisting of: 2,3,3-trifluoro-1-propene (CHF₂CF═CH₂); 1,1,2-trifluoro-1-propene (CH₃CF═CF₂); 1,2,3-trifluoro-1-propene (CH₂FCF═CF₂); 1,1,3-trifluoro-1-propene (CH₂FCH═CF₂); 1,3,3-trifluoro-1-propene (CHF₂CH═CHF); 1,1,1,2,4,4,4-heptafluoro-2-butene (CF₃CF═CHCF₃); 1,2,3,3,4,4,4-heptafluoro-1-butene (CHF═CFCF₂CF₃); 1,1,1,2,3,4,4-heptafluoro-2-butene (CHF₂CF═CFCF₃); 1,3,3,3-tetrafluoro-2-(trifluoromethyl)-1-propene ((CF₃)₂C═CHF); 1,1,3,3,4,4,4-heptafluoro-1-butene (CF₂═CHCF₂CF₃); 1,1,2,3,4,4,4-heptafluoro-1-butene (CF₂═CFCHFCF₃); 1,1,2,3,3,4,4-heptafluoro-1-butene (CF₂═CFCF₂CHF₂); 2,3,3,4,4,4-hexafluoro-1-butene (CF₃CF₂CF═CH₂); 1,3,3,4,4,4-hexafluoro-1-butene (CHF═CHCF₂CF₃); 1,2,3,4,4,4-hexafluoro-1-butene (CHF═CFCHFCF₃); 1,2,3,3,4,4-hexafluoro-1-butene (CHF═CFCF₂CHF₂); 1,1,2,3,4,4-hexafluoro-2-butene (CHF₂CF═CFCHF₂); 1,1,1,2,3,4-hexafluoro-2-butene (CH₂FCF═CFCF₃); 1,1,1,2,4,4-hexafluoro-2-butene (CHF₂CH═CFCF₃); 1,1,1,3,4,4-hexafluoro-2-butene (CF₃CH═CFCHF₂); 1,1,2,3,3,4-hexafluoro-1-butene (CF₂═CFCF₂CH₂F); 1,1,2,3,4,4-hexafluoro-1-butene (CF₂═CFCHFCHF₂); 3,3,3-trifluoro-2-(trifluoromethyl)-1-propene (CH₂═C(CF₃)₂); 1,1,1,2,4-pentafluoro-2-butene (CH₂FCH═CFCF₃); 1,1,1,3,4-pentafluoro-2-butene (CF₃CH═CFCH₂F); 3,3,4,4,4-pentafluoro-1-butene (CF₃CF₂CH═CH₂); 1,1,1,4,4-pentafluoro-2-butene (CHF₂CH═CHCF₃); 1,1,1,2,3-pentafluoro-2-butene (CH₃CF═CFCF₃); 2,3,3,4,4-pentafluoro-1-butene (CH₂═CFCF₂CHF₂); 1,1,2,4,4-pentafluoro-2-butene (CHF₂CF═CHCHF₂); 1,1,2,3,3-pentafluoro-1-butene (CH₃CF₂CF═CF₂); 1,1,2,3,4-pentafluoro-2-butene (CH₂FCF═CFCHF₂); 1,1,3,3,3-pentafluoro-2-methyl-1-propene (CF₂═C(CF₃)(CH₃)); 2-(difluoromethyl)-3,3,3-trifluoro-1-propene (CH₂═C(CHF₂)(CF₃)); 2,3,4,4,4-pentafluoro-1-butene (CH₂═CFCHFCF₃); 1,2,4,4,4-pentafluoro-1-butene (CHF═CFCH₂CF₃); 1,3,4,4,4-pentafluoro-1-butene (CHF═CHCHFCF₃); 1,3,3,4,4-pentafluoro-1-butene (CHF═CHCF₂CHF₂); 1,2,3,4,4-pentafluoro-1-butene (CHF═CFCHFCHF₂); 3,3,4,4-tetrafluoro-1-butene (CH₂═CHCF₂CHF₂); 1,1-difluoro-2-(difluoromethyl)-1-propene (CF₂═C(CHF₂)(CH₃)); 1,3,3,3-tetrafluoro-2-methyl-1-propene (CHF═C(CF₃)(CH₃)); 3,3-difluoro-2-(difluoromethyl)-1-propene (CH₂═C(CHF₂)₂); 1,1,1,2-tetrafluoro-2-butene (CF₃CF═CHCH₃); 1,1,1,3-tetrafluoro-2-butene (CH₃CF═CHCF₃); 1,1,1,4,4,4-hexafluoro-2-(trifluoromethyl)-2-butene ((CF₃)₂C═CHCF₃); 1,1,1,2,4,4,5,5,5-nonafluoro-2-pentene (CF₃CF═CHCF₂CF₃); 1,1,1,3,4,4,5,5,5-nonafluoro-2-pentene (CF₃CH═CFCF₂CF₃); 1,2,3,3,4,4,5,5,5-nonafluoro-1-pentene (CHF═CFCF₂CF₂CF₃); 1,1,3,3,4,4,5,5,5-nonafluoro-1-pentene (CF₂═CHCF₂CF₂CF₃); 1,1,2,3,3,4,4,5,5-nonafluoro-1-pentene (CF₂═CFCF₂CF₂CHF₂); 1,1,2,3,4,4,5,5,5-nonafluoro-2-pentene (CHF₂CF═CFCF₂CF₃); 1,1,1,2,3,4,4,5,5-nonafluoro-2-pentene (CF₃CF═CFCF₂CHF₂); 1,1,1,2,3,4,5,5,5-nonafluoro-2-pentene (CF₃CF═CFCHFCF₃); 1,2,3,4,4,4-hexafluoro-3-(trifluoromethyl)-1-butene (CHF═CFCF(CF₃)₂); 1,1,2,4,4,4-hexafluoro-3-(trifluoromethyl)-1-butene (CF₂═CFCH(CF₃)₂); 1,1,1,4,4,4-hexafluoro-2-(trifluoromethyl)-2-butene (CF₃CH═C(CF₃)₂); 1,1,3,4,4,4-hexafluoro-3-(trifluoromethyl)-1-butene (CF₂═CHCF(CF₃)₂); 2,3,3,4,4,5,5,5-octafluoro-1-pentene (CH₂═CFCF₂CF₂CF₃); 1,2,3,3,4,4,5,5-octafluoro-1-pentene (CHF═CFCF₂CF₂CHF₂); 3,3,4,4,4-pentafluoro-2-(trifluoromethyl)-1-butene (CH₂═C(CF₃)CF₂CF₃); 1,1,4,4,4-pentafluoro-3-(trifluoromethyl)-1-butene (CF₂═CHCH(CF₃)₂); 1,3,4,4,4-pentafluoro-3-(trifluoromethyl)-1-butene (CHF═CHCF(CF₃)₂); 1,1,4,4,4-pentafluoro-2-(trifluoromethyl)-1-butene (CF₂═C(CF₃)CH₂CF₃); 3,4,4,4-tetrafluoro-3-(trifluoromethyl)-1-butene ((CF₃)₂CFCH═CH₂); 3,3,4,4,5,5,5-heptafluoro-1-pentene (CF₃CF₂CF₂CH═CH₂); 2,3,3,4,4,5,5-heptafluoro-1-pentene (CH₂═CFCF₂CF₂CHF₂); 1,1,3,3,5,5,5-heptafluoro-1-butene (CF₂═CHCF₂CH₂CF₃); 1,1,1,2,4,4,4-heptafluoro-3-methyl-2-butene (CF₃CF═C(CF₃)(CH₃)); 2,4,4,4-tetrafluoro-3-(trifluoromethyl)-1-butene (CH₂═CFCH(CF₃)₂); 1,4,4,4-tetrafluoro-3-(trifluoromethyl)-1-butene (CHF═CHCH(CF₃)₂); 1,1,1,4-tetrafluoro-2-(trifluoromethyl)-2-butene (CH₂FCH═C(CF₃)₂); 1,1,1,3-tetrafluoro-2-(trifluoromethyl)-2-butene (CH₃CF═C(CF₃)₂); 1,1,1-trifluoro-2-(trifluoromethyl)-2-butene ((CF₃)₂C═CHCH₃); 3,4,4,5,5,5-hexafluoro-2-pentene (CF₃CF₂CF═CHCH₃); 1,1,1,4,4,4-hexafluoro-2-methyl-2-butene (CF₃C(CH₃)═CHCF₃); 3,3,4,5,5,5-hexafluoro-1-pentene (CH₂═CHCF₂CHFCF₃); 4,4,4-trifluoro-3-(trifluoromethyl)-1-butene (CH₂═C(CF₃)CH₂CF₃); 1,1,1,4,4,5,5,5-octafluoro-2-(trifluoromethyl)-2-pentene ((CF₃)₂C═CHC₂F₅); 1,1,1,3,4,5,5,5-octafluoro-4-(trifluoromethyl)-2-pentene ((CF₃)₂CFCF═CHCF₃); 3,3,4,4,5,5,6,6,6-nonafluoro-1-hexene (CF₃CF₂CF₂CF₂CH═CH₂); 4,4,4-trifluoro-3,3-bis(trifluoromethyl)-1-butene (CH₂═CHC(CF₃)₃); 1,1,1,4,4,4-hexafluoro-2-(trifluoromethyl)-3-methyl-2-butene ((CF₃)₂C═C(CH₃)(CF₃)); 2,3,3,5,5,5-hexafluoro-4-(trifluoromethyl)-1-pentene (CH₂═CFCF₂CH(CF₃)₂); 1,1,1,2,4,4,5,5,5-nonafluoro-3-methyl-2-pentene (CF₃CF═C(CH₃)CF₂CF₃); 1,1,1,5,5,5-hexafluoro-4-(trifluoromethyl)-2-pentene (CF₃CH═CHCH(CF₃)₂); 3,4,4,5,5,6,6,6-octafluoro-2-hexene (CF₃CF₂CF₂CF═CHCH₃); 3,3,4,4,5,5,6,6-octafluorol-hexene (CH₂═CHCF₂CF₂CF₂CHF₂); 1,1,1,4,4-pentafluoro-2-(trifluoromethyl)-2-pentene ((CF₃)₂C═CHCF₂CH₃); 4,4,5,5,5-pentafluoro-2-(trifluoromethyl)-1-pentene (CH₂═C(CF₃)CH₂C₂F₅); 3,3,4,4,5,5,5-heptafluoro-2-methyl-1-pentene (CF₃CF₂CF₂C(CH₃)═CH₂); 4,4,5,5,6,6,6-heptafluoro-2-hexene (CF₃CF₂CF₂CH═CHCH₃); 4,4,5,5,6,6,6-heptafluoro-1-hexene (CH₂═CHCH₂CF₂C₂F₅); 1,1,1,2,2,3,4-heptafluoro-3-hexene (CF₃CF₂CF═CFC₂H₅); 4,5,5,5-tetrafluoro-4-(trifluoromethyl)-1-pentene (CH₂═CHCH₂CF(CF₃)₂); 1,1,1,2,5,5,5-heptafluoro-4-methyl-2-pentene (CF₃CF═CHCH(CF₃)(CH₃)); 1,1,1,3-tetrafluoro-2-(trifluoromethyl)-2-pentene ((CF₃)₂C═CFC₂H₅); 1,1,1,3,4,4,5,5,6,6,7,7,7-tridecafluoro-2-heptene (CF₃CH═CFCF₂CF₂C₂F₅); 1,1,1,2,4,4,5,5,6,6,7,7,7-tridecafluoro-2-heptene (CF₃CF═CHCF₂CF₂C₂F₅); 1,1,1,2,2,4,5,5,6,6,7,7,7-tridecafluoro-3-heptene (CF₃CF₂CH═CFCF₂C₂F₅); 1,1,1,2,2,3,5,5,6,6,7,7,7-tridecafluoro-3-heptene (CF₃CF₂CF═CHCF₂C₂F₅).

In this disclosure, HCFC-1233xf and hydrofluoroolefins are used as blowing agents. Typically these are combined prior to mixing with the other components in the foam-forming compositions. Alternatively, one can be mixed with some or all of the other components in the foam-forming compositions before the other is mixed in. For example, cis-1,1,1,4,4,4-hexafluoro-2-butene (Z-FC-1336mzz, Z—CF₃CH═CHCF₃) can be first mixed with the other components in the foam-forming compositions before HCFC-1233xf is added in. In one embodiment, the mixture of HCFC-1233xf and at least one hydrofluoroolefin contains from 1 to 25 wt % of Z-FC-1336mzz, and from 99 to 75 wt % of HCFC-1233xf. In one embodiment, the mixture of HCFC-1233xf and at least one hydrofluoroolefin contains from 3 to 22 wt % of Z-FC-1336mzz and from 97 to 78 wt % of HCFC-1233xf.

By “hydrofluoroolefin”, it is meant to refer to compounds containing hydrogen, carbon, fluorine, and at least one carbon-carbon double bond.

In some embodiments of this invention, hydrofluoroolefin is Z-FC-1336mzz.

Z-FC-1336mzz is a known compound, and its preparation method has been disclosed, for example, in U.S. Patent Application No. 60/926,293 [FL1346 US PRV] filed Apr. 26, 2007, hereby incorporated by reference in its entirety.

HCFC-1233xf can be prepared by dehydrochlorination of 1,2-dichloro-3,3,3-trifluoropropane using potassium hydroxide as described by Haszeldine in Journal of the Chemical Society (1951) pages 2495 to 2504.

By “cream time”, it is meant to refer to the time period starting from the mixing of the active hydrogen-containing compound with polyisocyanate, and ending at when the foaming starts to occur and color of the mixture starts to change.

By “rise time”, it is meant to refer to the time period starting from the mixing of the active hydrogen-containing compound with polyisocyanate, and ending at when the foam rising stops.

By “tack free time”, it is meant to refer to the time period starting from the mixing of the active hydrogen-containing compound with polyisocyanate, and ending at when the surface of the foam is no longer tacky.

By “initial R-value”, it is meant to refer to the polymer foam's insulation value (thermal resistance) measured at a mean temperature of 75° F. within 24 hours after the foam is formed and becomes tack free.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

The active hydrogen-containing compounds of this invention can comprise compounds having two or more groups that contain an active hydrogen atom reactive with an isocyanate group, such as described in U.S. Pat. No. 4,394,491; hereby incorporated by reference. In some embodiments of this invention, the group containing an active hydrogen atom is in the form of a hydroxyl group. In some embodiments of this invention, the active hydrogen-containing compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene—and/or propylene oxide—to form an extended polyester polyol containing additional internal alkyleneoxy groups.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include alaphatic or aromatic amine-based and Mannich base polyols.

In some embodiments of this invention, the active hydrogen-containing compound is a mixture of polyether polyol and polyester polyol.

The present invention also relates to processes for producing a closed-cell polyurethane or polyisocyanurate polymer foam by reacting an effective amount of the foam-forming compositions with a suitable polyisocyanate.

Typically, before reacting with a suitable polyisocyanate, the active hydrogen-containing compound described hereinabove and optionally other additives are mixed with the blowing agents (e.g., Z-FC-1336mzz and HCFC-1233xf) to form a foam-forming composition. Such foam-forming composition is typically known in the art as an isocyanate-reactive preblend, or B-side composition. The foam-forming composition of this invention can be prepared in any manner convenient to one skilled in this art, including simply weighing desired quantities of each component and, thereafter, combining them in an appropriate container at appropriate temperatures and pressures.

When preparing polyisocyanate-based foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyisocyanate-based foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4-biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyisocyanate-based foams. Among these additives comprise one or more members from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. blowing agents+active hydrogen-containing compounds+polyisocyanates+additives) are used. In another embodiment of this invention, about 1.5% to about 3% by weight of surfactant based on the total weight of all foaming ingredients are used.

One or more catalysts for the reaction of the active hydrogen-containing compounds, e.g. polyols, with the polyisocyanate may be also employed. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

In the process of the invention for making a polyisocyanate-based foam, the active hydrogen-containing compound (e.g. polyol), polyisocyanate and other components are contacted, thoroughly mixed, and permitted to expand and cure into a cellular polymer. The mixing apparatus is not critical, and various conventional types of mixing head and spray apparatus are used. By conventional apparatus is meant apparatus, equipment, and procedures conventionally employed in the preparation of isocyanate-based foams in which conventional isocyanate-based foam blowing agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France. These disclosures are hereby incorporated by reference.

In one embodiment of this invention, a preblend of certain raw materials is prepared prior to reacting the polyisocyanate and active hydrogen-containing components. For example, it is often useful to blend the polyol(s), blowing agent, surfactant(s), catalysts(s) and other foaming ingredients, except for polyisocyanates, and then contact this blend with the polyisocyanate. Alternatively, all the foaming ingredients may be introduced individually to the mixing zone where the polyisocyanate and polyol(s) are contacted. It is also possible to pre-react all or a portion of the polyol(s) with the polyisocyanate to form a prepolymer.

The invention composition and processes are applicable to the production of all kinds of expanded polyurethane foams, including, for example, integral skin, RIM and flexible foams, and in particular rigid closed-cell polymer foams useful in spray insulation, as pour-in-place appliance foams, or as rigid insulating board stock and laminates.

The present invention also relates to the closed-cell polyurethane or polyisocyanurate polymer foams prepared from reaction of effective amounts of the foam-forming composition of this disclosure and a suitable polyisocyanate.

In some embodiments of this invention, the closed-cell polyurethane or polyisocyanurate polymer foam has an initial R-value greater than 7.0 ft²-hr-° F./BTU-in.

Many aspects and embodiments have been described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims.

Polyol A is a Mannich base polyether polyol (JEFFOL 315×) from Huntsman Polyurethanes at West Deptford, N.J. 08066-1723. Polyol A has viscosity of 2400 centerpoise at 25° C. The content of hydroxyl groups in the Polyol is equivalent to 336 mg KOH per gram of Polyol.

Polyol B is a polyester polyol (Terate 2031) from Invista Polyurethanes at Wichita, Kans. 67220. Polyol B has viscosity of 10,000 centerpoise at 25° C. The content of hydroxyl groups in the Polyol is equivalent to 307 mg KOH per gram of Polyol.

Surfactant (DABCO DC193) is polysiloxane purchased from Air Products Inc. at 7201 Hamilton Blvd, Allentown Pa. 18195

Blowing agent enhancer (DABCO PM300) is 2-butoxyethanol from Air Products Inc. at 7201 Hamilton Blvd, Allentown Pa. 18195

Amine catalyst (Polycat 30) is tertiary amine purchased from Air Products Inc. at 7201 Hamilton Blvd, Allentown Pa. 18195.

Potassium catalyst (Potassium HEX-CEM 977) contains 25 wt % diethylene glycol and 75 wt % potassium 2-ethylhexanoate purchased from OMG Americas Inc. at 127 Public Square, 1500 Key Tower, Cleveland Ohio 44114.

Fire retardant (PUMA 4010) is tris-(1-chloro-2-propyl)phosphate (TCPP) purchased from ExpoMix Corporation at Wauconda, Ill. 60084.

Polymethylene polyphenyl isocyanate (PAPI 27) is purchased from Dow Chemicals, Inc. at Midland, Mich., 49641-1206.

Initial R-value is measured by a LaserComp FOX 304 Thermal Conductivity Meter at a mean temperature of 75° F. The unit of R-value is ft²-hr-° F./BTU-in.

### Example 1

### Polyurethane Foam Made from HCFC-1233xf

Polyols, surfactant, blowing agent enhancer, fire retardant, catalysts, water and the blowing agent (HCFC-1233xf) were pre-mixed by hand and then mixed with polyisocyanate. The resulting mixture was poured into a 8″×8″×2.5″ paper box to form the polyurethane foam. The formulation and properties of the foam are shown in Tables 1 and 2 below.

TABLE 1
Polyurethane formulation using HCFC-1233xf

| Component | Parts by weight |
|---|---|
| Polyol A | 50 |
| Polyol B | 50 |
| Surfactant | 0.25 |
| Blowing agent enhancer | 3.00 |
| Fire retardant | 21.5 |
| Amine catalyst | 0.97 |
| Potassium catalyst | 0.25 |
| Water | 0.63 |
| Blowing agent (HCFC-1233xf) | 23.4 |
| Polymethylene polyphenyl isocyanate | 97 |

TABLE 2
Polyurethane foam properties using HCFC-1233xf

| | |
|---|---|
| Foam Index | 1.1 |
| Cream time(second) | 7 |
| Rise time (seconds) | 70 |
| Tack free time(seconds) | 70 |
| Foam density (pounds-per-cubic-feet) | 2.68 |
| Initial R-value (ft²-hr-° F./BTU-in) | 7.3 |

### Example 2

### Polyurethane Foam Made from Z-FC-1336mzz

Polyols, surfactant, blowing agent enhancer, fire retardant, catalysts, water and the blowing agent (Z-FC-1336mzz) were pre-mixed by hand and then mixed with polyisocyanate. The resulting mixture was poured into a 8″×8″×2.5″ paper box to form the polyurethane foam. The formulation and properties of the foam are shown in Tables 3 and 4 below.

TABLE 3
Polyurethane formulation using Z-FC-1336mzz

| Component | Parts by weight |
|---|---|
| Polyol A | 50 |
| Polyol B | 50 |
| Surfactant | 0.25 |
| Blowing agent enhancer | 3.00 |
| Fire retardant | 21.5 |
| Amine catalyst | 0.97 |
| Potassium catalyst | 0.25 |
| Water | 0.63 |
| Blowing agent (Z-FC-1336mzz) | 29.4 |
| Polymethylene polyphenyl isocyanate | 97 |

TABLE 4
Polyurethane foam properties using Z-FC-1336mzz

| | |
|---|---|
| Foam Index | 1.1 |
| Cream time(second) | 7 |
| Rise time (seconds) | 71 |
| Tack free time(seconds) | 85 |
| Foam density (pounds-per-cubic-feet) | 2.76 |
| Initial R-value (ft²-hr-° F./BTU-in) | 7.7 |

### Example 3

### Polyurethane Foam Made from the Mixture of Z-FC-1336mzz and HCFC-1233xf

Blowing agents Z-FC-1336mzz and HCFC-1233xf were premixed to form a mixture containing 50 wt % of Z-FC-1336mzz and 50 wt % of HCFC-1233xf.

Polyols, surfactant, blowing agent enhancer, fire retardant, catalysts, water and the blowing agent mixture made above (50 wt % of HCFC-1233xf and 50 wt % of Z-FC-1336mzz) were pre-mixed by hand and then mixed with polyisocyanate. The resulting mixture was poured into a 8″×8″×2.5″ paper box to form the polyurethane foam. The formulation and properties of the foam are shown in Tables 5 and 6 below. As shown in Table 6, the addition of Z-FC-1336mzz into HCFC-1233xf improved the R-value of the foam.

TABLE 5
Polyurethane formulation using FC-1336mzz and HCFC-1233xf
mixture

| Component | Parts by weight |
|---|---|
| Polyol A | 50 |
| Polyol B | 50 |
| Surfactant | 0.25 |
| Blowing agent enhancer | 3.00 |
| Fire retardant | 21.5 |
| Amine catalyst | 0.97 |
| Potassium catalyst | 0.25 |
| Water | 0.63 |
| Blowing agent (50 wt % Z-FC-1336mzz and 50 wt | 26.0 |
| % HCFC-1233xf) | |
| Polymethylene polyphenyl isocyanate | 97 |

TABLE 6
Polyurethane foam properties using FC-1336mzz and HCFC-
1233xf mixture

| | |
|---|---|
| Foam Index | 1.1 |
| Cream time(second) | 6 |
| Rise time (seconds) | 70 |
| Tack free time(seconds) | 80 |
| Foam density (pounds-per-cubic-feet) | 2.89 |
| Initial R-value (ft²-hr-° F./BTU-in) | 7.7 |

What is claimed is:

1. A foam-forming composition comprising:
(a) a mixture of 2-chloro-3,3,3-trifluoropropene and at least one hydrofluoroolefin; and
(b) an active hydrogen-containing compound having two or more active hydrogens; wherein said at least one hydrofluoroolefin is selected from the group consisting of:
(i) hydrofluoroolefins of the formula E- or Z—R¹CH═CHR², wherein R¹ and R² are, independently, C₁ to C₆ perfluoroalkyl groups;
(ii) cyclic hydrofluoroolefins of the formula cyclo-[CX═CY(CZW)ₙ—], wherein X, Y, Z, and W, independently, are H or F, and n is an integer from 2 to 5, provided that not all X, Y, Z, and W are F; and
(iii) hydrofluoroolefins selected from the group consisting of: CHF₂CF═CH₂, CH₃CF═CF₂, CH₂FCF═CF₂, CH₂FCH═CF₂, CHF₂CH═CHF, CF₃CF═CHCF₃, CHF═CFCF₂CF₃, CHF₂CF═CFCF₃, (CF₃)₂C═CHF, CF₂═CHCF₂CF₃, CF₂═CFCHFCF₃, CF₂═CFCF₂CHF₂, CF₃CF₂CF═CH₂, CHF═CHCF₂CF₃, CHF═CFCHFCF₃, CHF═CFCF₂CHF₂, CHF₂CF═CFCHF₂, CH₂FCF═CFCF₃, CHF₂CH═CFCF₃, CF₃CH═CFCHF₂, CF₂═CFCF₂CH₂F, CF₂═CFCHFCHF₂, CH₂═C(CF₃)₂, CH₂FCH═CFCF₃, CF₃CH═CFCH₂F, CF₃CF₂CH═CH₂, CHF₂CH═CHCF₃, CH₃CF═CFCF₃, CH₂═CFCF₂CHF₂, CHF₂CF═CHCHF₂, CH₃CF₂CF═CF₂, CH₂FCF═CFCHF₂, CF₂═C(CF₃)(CH₃), CH₂═C(CHF₂)(CF₃), CH₂═CFCHFCF₃, CHF═CFCH₂CF₃, CHF═CHCHFCF₃, CHF═CHCF₂CHF₂, CHF═CFCHFCHF₂, CH₂═CHCF₂CHF₂, CF₂═C(CHF₂)(CH₃), CHF═C(CF₃)(CH₃), CH₂═C(CHF₂)₂, CF₃CF═CHCH₃, CH₃CF═CHCF₃, (CF₃)₂C═CHCF₃, CF₃CF═CHCF₂CF₃, CF₃CH═CFCF₂CF₃, CHF═CFCF₂CF₂CF₃, CF₂═CHCF₂CF₂CF₃, CF₂═CFCF₂CF₂CHF₂, CHF₂CF═CFCF₂CF₃, CF₃CF═CFCF₂CHF₂, CF₃CF═CFCHFCF₃, CHF═CFCF(CF₃)₂, CF₂═CFCH(CF₃)₂, CF₃CH═C(CF₃)₂, CF₂═CHCF(CF₃)₂, CH₂═CFCF₂CF₂CF₃, CHF═CFCF₂CF₂CHF₂, CH₂═C(CF₃)CF₂CF₃, CF₂═CHCH(CF₃)₂, CHF═CHCF(CF₃)₂, CF₂═C(CF₃)CH₂CF₃, (CF₃)₂CFCH═CH₂, CF₃CF₂CF₂CH═CH₂, CH₂═CFCF₂CF₂CHF₂, CF₂═CHCF₂CH₂CF₃, CF₃CF═C(CF₃)(CH₃), CH₂═CFCH(CF₃)₂, CHF═CHCH(CF₃)₂, CH₂FCH═C(CF₃)₂, CH₃CF═C(CF₃)₂, (CF₃)₂C═CHCH₃, CF₃CF₂CF═CHCH₃, CF₃C(CH₃)═CHCF₃, CH₂═CHCF₂CHFCF₃, CH₂═C(CF₃)CH₂CF₃, (CF₃)₂C═CHC₂F₅, (CF₃)₂CFCF═CHCF₃, CF₃CF₂CF₂CF₂CH═CH₂, CH₂═CHC(CF₃)₃, (CF₃)₂C═C(CH₃)(CF₃), CH₂═CFCF₂CH(CF₃)₂, CF₃CF═C(CH₃)CF₂CF₃, CF₃CH═CHCH(CF₃)₂, CF₃CF₂CF₂CF═CHCH₃, CH₂═CHCF₂CF₂CF₂CHF₂, (CF₃)₂C═CHCF₂CH₃, CH₂═C(CF₃)CH₂C₂F₅, CF₃CF₂CF₂C(CH₃)═CH₂, CF₃CF₂CF₂CH═CHCH₃, CH₂═CHCH₂CF₂C₂F₅, CF₃CF₂CF═CFC₂H₅, CH₂═CHCH₂CF(CF₃)₂, CF₃CF═CHCH(CF₃)(CH₃), (CF₃)₂C═CFC₂H₅, CF₃CH═CFCF₂CF₂C₂F₅, CF₃CF═CHCF₂CF₂C₂F₅, CF₃CF₂CH═CFCF₂C₂F₅, CF₃CF₂CF═CHCF₂C₂F₅.

2. The foam-forming composition of claim 1 wherein said at least one hydrofluoroolefin is cis-1,1,1,4,4,4-hexafluoro-2-butene.

3. The foam-forming composition of claim 1 wherein said active hydrogen-containing compound is a mixture of polyether polyol and polyester polyol.

4. A closed-cell polyurethane or polyisocyanurate polymer foam prepared from reaction of an effective amount of the foam-forming composition of claim 1 with a suitable polyisocyanate.

5. The closed-cell polyurethane or polyisocyanurate polymer foam of claim 4 wherein said polymer foam has an initial R-value greater than 7.0 ft²-hr-° F./BTU-in.

6. A process for producing a closed-cell polyurethane or polyisocyanurate polymer foam comprising: reacting an effective amount of the foam-forming composition of claim 1 with a suitable polyisocyanate.
